(19) United States
(12) Patent Application Publication
(10) Pub. No.: US 2022/0074459 A1
(43) Pub. Date: Mar. 10, 2022

(54) RESINOUS SPRING

(71) Applicant: HONDA MOTOR CO., LTD., Tokyo (JP)

(72) Inventors: Takayuki KAWAZOE, Wako-shi (JP); Kotaro TANAKA, Wako-shi (JP); Masanobu SEKI, Wako-shi (JP)

(21) Appl. No.: 17/466,492

(22) Filed: Sep. 3, 2021

(30) Foreign Application Priority Data
Sep. 7, 2020 (CN) 202010931695.0

(51) Int. Cl. F16F 1/373

(52) U.S. Cl. CPC F16F 1/3732; F16F 2234/02; F16F 2224/02; F16F 2228/007

(57) ABSTRACT

A resinous spring includes ring-shaped members disposed with gaps interposed therebetween in the direction of the spring axis and link members connecting adjacent ones of the ring-shaped members. Each ring-shaped member has vertex portions to each of which a first link member or a second link member is connectable, thin portions at which the ring-shaped member is reduced in thickness in the direction of the spring axis, and tapered portions at which the ring-shaped member is reduced in thickness in the direction of the spring axis gradually from the vertex portions to the thin portions.

### CROSS-REFERENCE TO RELATED APPLICATION

This application is based upon and claims priority from the Chinese Patent Application No. 202010931695.0, filed on Sep. 7, 2020, the entire contents of which are incorporated herein by reference.

### BACKGROUND OF THE INVENTION

### 1. Field of the Invention

The present invention relates to a resinous spring.

### 2. Description of the Related Art

Japanese Patent Application Publication No. H11-13804 describes a spring that is entirely and integrally formed of a synthetic resin material and includes a plurality of ring-shaped members coaxially arranged in parallel with appropriate gaps interposed therebetween and elastic link members linking the ring-shaped members to one another at a plurality of locations. Each elastic link member is disposed along an imaginary tubular surface defined by the ring-shaped members and forms a lying-down U shape curving in the circumferential direction of the ring-shaped members. The ring-shaped members are set such that adjacent ones have different diameters. Also, one end portion and the other end portion of each elastic link member are offset from each other in the radial direction of the ring-shaped members so as not to overlap with each other in the extension/contraction direction of the spring.

Japanese Patent Application Publication No. 2015-214367 describes a valve member having a press member, one end of which is supported by a housing member and other end of which is connected to a valve body, the press member having first to third ring portions arranged with gaps interposed therebetween in the direction of the center axis of the valve body, a plurality of first pillar portions connecting the first ring portion and the second ring portion to each other, and a plurality of second pillar portions connecting the second ring portion and the third ring portion to each other. The first pillar portions do not overlap with the second pillar portions when seen in the direction of the center axis of the valve body.

In order for a conventional resin spring to be able to support the weight of an object, the resin spring needs to have high rigidity to withstand a high-load stress. In order to increase the rigidity of a resin spring, there are no ways other than increasing the thickness or dimensions of the spring, which leads to weight increase. Such resin springs would have only a small difference in weight from iron springs, and then there is no point in using such resinous springs.

### SUMMARY OF THE INVENTION

The present invention has been made to solve the above problem and has an object to provide a lightweight resinous spring without compromising the rigidity of the spring.

To achieve the above object, the invention according to claim 1 is a resinous spring including: a plurality of ring-shaped members disposed with gaps interposed therebetween in an axial direction of the spring and link members connecting adjacent ones of the ring-shaped members. The link members include at least one first link member and at least one second link member for each of the ring-shaped member, the first link member and the second link member connecting the ring-shaped member to adjacent ones of the ring-shaped members on one side and the other side of the ring-shaped member, respectively. The first link member and the second link member are disposed at positions not facing each other in the axial direction of the spring. Each of the ring-shaped members includes vertex portions to each of which the first link member or the second link member is connectable, thin portions where the ring-shaped member is reduced in thickness in the axial direction of the spring, and tapered portions where the ring-shaped member is reduced in thickness in the axial direction of the spring gradually from the vertex portions to the thin portions.

The present invention can reduce the weight of a spring without compromising the rigidity of the spring.

### BRIEF DESCRIPTION OF THE DRAWINGS

FIG. 1 is a perspective view of a resinous spring according to an embodiment of the present invention.

FIG. 2 is a perspective view of a resinous spring of Comparative Example 1.

FIG. 3 is a diagram showing a distribution of stress exerted on the resinous spring of the comparative example shown in FIG. 2 when a load F is applied to the resinous spring from above.

FIGS. 4A and 4B are each a diagram illustrating the structure of a leaf spring constituting a ring-shaped member of a resinous spring according to the embodiment of the present invention.

FIG. 5 is a diagram showing a distribution of stress on the leaf spring in FIGS. 4A and 4B.

FIG. 6 is a diagram illustrating calculation formulae for the fixed end beam in FIGS. 4A and 4B.

FIG. 7 is a diagram illustrating the design of the thickness (height) h of the fixed end beam of the resinous spring according to the embodiment of the present invention.

FIG. 8 is a diagram showing a distribution of stress on the fixed end beam model constituting the ring-shaped member of the resinous spring according to the embodiment of the present invention.

FIG. 9 is a diagram showing a distribution of stress on a fixed end beam model of Comparative Example 2 for the resinous spring according to the embodiment of the present invention.

FIG. 10 is a structure sectional diagram showing a comparison between the tapered portions of the fixed end beam model of the resinous spring according to the embodiment of the present invention and the tapered portions of the fixed end beam model of Comparative Example 2.

FIG. 11 is a diagram showing a distribution of stress on a fixed end beam model of Comparative Example 3 for the resinous spring according to the embodiment of the present invention.

FIG. 12 is a structure sectional diagram showing a comparison between the tapered portions of the fixed end beam model of the resinous spring according to the embodiment of the present invention and the tapered portions of the fixed end beam model of Comparative Example 3.

FIG. 13 is a side view of a fixed end beam model of a resinous spring according to an embodiment of the present invention whose upper and lower surfaces are processed.

FIG. 14 is a diagram showing a distribution of stress on the fixed end beam model of the resinous spring according to the embodiment of the present invention.

FIG. 15 is a side view showing a fixed end beam model of a resinous spring according to an embodiment of the present invention whose upper surface is processed.

FIG. 16 is a side view showing a fixed end beam model of a resinous spring according to an embodiment of the present invention whose lower surface is processed.

FIG. 17 is a schematic view illustrating the arrangement of the link members of a resinous spring according to an embodiment of the present invention in a case with one first link member and one second link member.

FIG. 18 is a schematic view illustrating the arrangement of the link members of a resinous spring according to an embodiment of the present invention in a case with two first link members and two second link members.

FIG. 19 is a schematic view illustrating the arrangement of the two kinds of link members of a resinous spring according to an embodiment of the present invention in a case with three first link members and three second link members.

FIG. 20 is a schematic view illustrating the arrangement of the link members of a resinous spring according to an embodiment of the present invention in a case with four first link members and four second link members.

FIG. 21 is a perspective view schematically showing the vertical gaps between ring-shaped members of a resinous spring according to an embodiment of the present invention.

FIG. 22 is a diagram showing a distribution of stress exerted on the resinous spring according to the embodiment of the present invention when a load F is applied to the spring from above.

FIG. 23 is a perspective view showing a ring-shaped member of the resinous spring according to the embodiment of the present invention.

### DETAILED DESCRIPTION OF THE EMBODIMENTS

Hereinbelow, a resinous spring according to an embodiment of the present invention is described in detail with reference to the drawings as needed. Throughout the drawings, the same parts are denoted by the same reference numerals to avoid repetition of description. Also, for the convenience of illustration, some drawings may show members schematically with their sizes and shapes modified or exaggerated.

### [Basic Structure of the Resinous Spring 1]

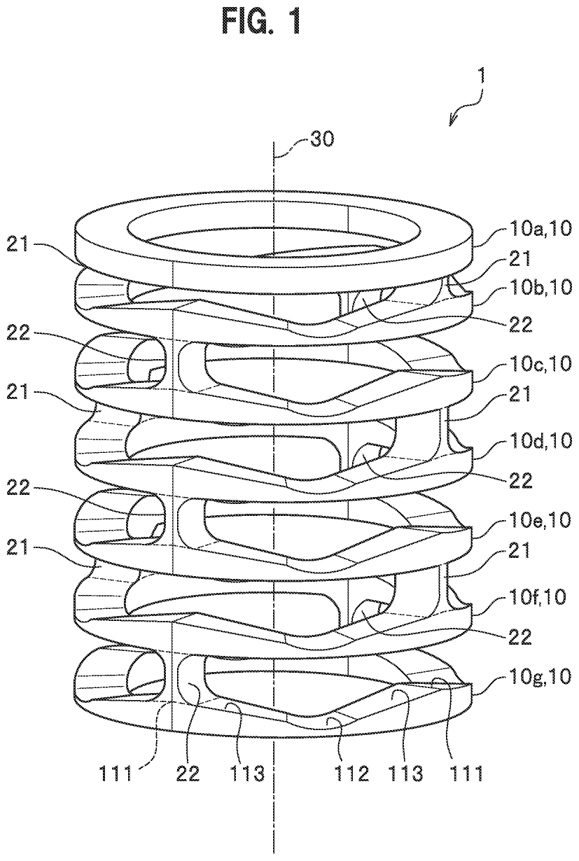

FIG. 1 is a perspective diagram of a resinous spring according to an embodiment of the present invention.

A resinous spring 1 according to the present embodiment is a hollow cylindrical spring used for, for example, a suspension. The resinous spring 1 is an injection-molded resin spring and can be manufactured by injection molding.

As shown in FIG. 1, the resinous spring 1 includes a plurality of ring-shaped members 10a to 10g (a plurality of ring-shaped members) arranged with gaps interposed therebetween in the vertical direction to form a plurality layers (in a stacking manner) and link members 21, 22 (a plurality of link members) connecting the ring-shaped members 10a to 10g adjacent in the vertical direction.

The uppermost ring-shaped member 10a has coaxial external and internal cylinders and has an even thickness in the vertical direction (the direction of a spring axis 30). A section of the ring-shaped member 10a taken in the vertical direction is a rectangle which is longer radially.

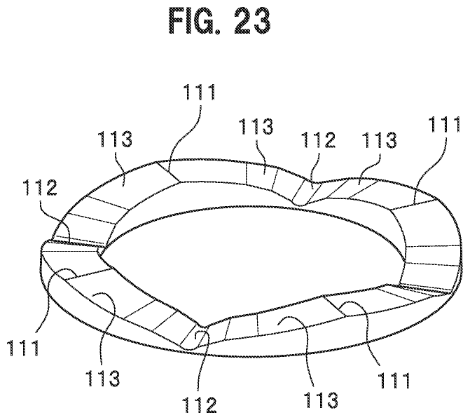

FIG. 23 is a perspective view of one of the ring-shaped members 10b to 10g shown in FIG. 1.

As shown in FIG. 23, the ring-shaped members 10b to 10g have basically the same shape except for the portions connected to the link members 21, 22 and is shaped as if the plate thickness of the ring-shaped member 10a were partially scraped off from its upper surface.

As shown in FIG. 1, the center axes of the respective ring-shaped members 10a to 10g extend vertically and disposed at the same position, aligning with the spring axis 30.

The ring-shaped members 10a to 10g are connected to one another such that a given ring-shaped member is connected to a first adjacent ring-shaped member by the first link members 21 at two locations and connected to a second adjacent ring-shaped member by the second link members 22 at two locations, the second adjacent ring-shaped member being vertically adjacent in a direction different from the first ring-shaped member connected by the first link members 21.

The link members 21, 22 include at least one first link member 21 and at least one second link member 22 for each of the ring-shaped members 10b to 10g, the first link member 21 and the second link member 22 connecting the ring-shaped member 10b to 10g to adjacent ones of the ring-shaped members 10b to 10g on one side and the other side of the ring-shaped member 10b to 10g, respectively.

The first link members 21 at two locations are disposed at positions facing each other across the spring axis 30 (two rotationally symmetric positions) and the second link members 22 at two locations are also similarly disposed at positions facing each other across the spring axis 30.

The second link members 22 are disposed at positions offset from the positions of the first link members 21 by 90° in the circumferential direction of the ring-shaped members 10a to 10g. In other words, the link members 21, 22 are disposed such that a line connecting the first link members 21 at the two locations and a line connecting the second link members 22 at the two locations are orthogonal to each other in a plan view (i.e., in a plan view, the first link members 21 and the second link members 22 are disposed at four positions rotationally symmetric with respect to the spring axis 30).

As shown in FIG. 1, the first link members 21 connected to the respective ring-shaped members 10b, 10d, 10f are disposed at the same circumferential positions with respect to the spring axis 30 in the same vertical connecting directions. The same is true of the second link members 22. The first link members 21 connected to the ring-shaped members 10b, 10d, 10f are connected to the ring-shaped members thereabove, and the second link members 22 connected to the ring-shaped members 10b, 10d, 10f are connected to the ring-shaped members therebelow. The first link members 21 and the second link members 22 connected to the ring-shaped members 10b, 10d, 10f are connected in the opposite directions vertically from those connected to the ring-shaped members 10c, 10e.

The first ring-shaped members connecting the ring-shaped members 10a to 10g are disposed at positions aligning with one another vertically (i.e., positions facing one another in the vertical direction), in such a manner as to connect adjacent ring-shaped members in the vertical direction, skip one ring-shaped member, and then connect another adjacent ring-shaped members. The same is true of the second ring-shaped members connecting the ring-shaped members 10a to 10g.

Note that the ring-shaped members 10a to 10g may be generically referred to as ring-shaped members 10. Although the ring-shaped members 10 in the present embodiment have a circular (perfectly circular) donut shape in a plan view, they may have an oval donut shape or a polygonal donut shape.

Each of the ring-shaped members 10 includes vertex portions 111 to which the link members 21, 22 are connectable, thin portions 112 where the ring-shaped member 10 is reduced in thickness vertically, and tapered portions 113 where the ring-shaped member 10 is reduced in thickness vertically gradually from the vertex portions 111 to the thin portions 112.

The thin portions 112 are disposed at positions offset from the positions of the vertex portions 111 by 45° in the circumferential direction of the ring-shaped member 10 (i.e., each thin portion 112 is disposed at a halfway point between two vertex portions 111 adjacent in the circumferential direction of the ring-shaped member 10).

As will be described later, the thickness of each thin portion 112 is theoretically zero, but then injection molding would be difficult. For this reason, in order for the thin portion 112 to have a minimum moldable thickness, the ring-shaped member 10 is shaped such that the tapered portions 113 on the left and right sides of the thin portion 112 are smoothly continuous with each other, and an area in the vicinity of this thinnest portion is the thin portion.

As shown in FIG. 23, the ring-shaped members 10b to 10g each have four vertex portions 111 having the same shape and four thin portions 112 having the same shape. In other words, each of the ring-shaped members 10b to 10g has four shapes rotationally symmetric with respect to the axis of the ring-shaped member 10.

The ring-shaped members 10a to 10g may have a section of any one of a round shape, a square shape, and a polygonal shape.

Instead of having the varying thickness axially, the ring-shaped member 10a may have an uneven thickness like the other ring-shaped members 10. In that case, the ring-shaped member 10a is desirably disposed with the surface without the varying thickness (the flat surface) facing upward.

Also, instead of having the varying thickness vertically, the ring-shaped member 10g may have an even thickness vertically like the ring-shaped member 10a.

Although the ring-shaped members 10b to 10f are each disposed with the uneven thickness surface facing upward (it is desirable to have the uneven thickness surface facing upward as will be described later), the ring-shaped members 10b to 10f may have an uneven surface on the lower side or on both of the upper and lower sides, due to reasons such as molding of the spring or layout of the spring.

### [Operation of the Resinous Spring According to the Present Embodiment]

Next, with reference to the drawings as needed, a description is given of the operation of the resinous spring according to the present embodiment by comparing it with a resinous spring 1000 according to a comparative example.

### Comparative Example

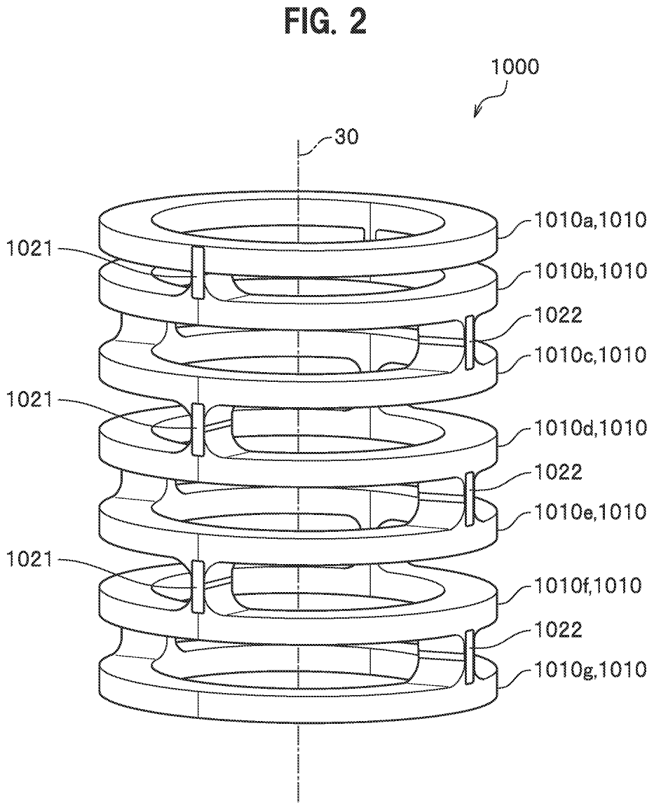

FIG. 2 is a perspective view of the resinous spring 1000 of Comparative Example 1.

As shown in FIG. 2, the resinous spring 1000 of Comparative Example 1 includes, like the resinous spring 1 of the present embodiment, a plurality of ring-shaped members 1010a to 1010g disposed with gaps interposed therebetween and a plurality of link members 1021, 1022 connecting adjacent ones of the ring-shaped members 1010a to 1010g.

The resinous spring 1000 is the resinous spring 1 without the thin portions and the tapered portions.

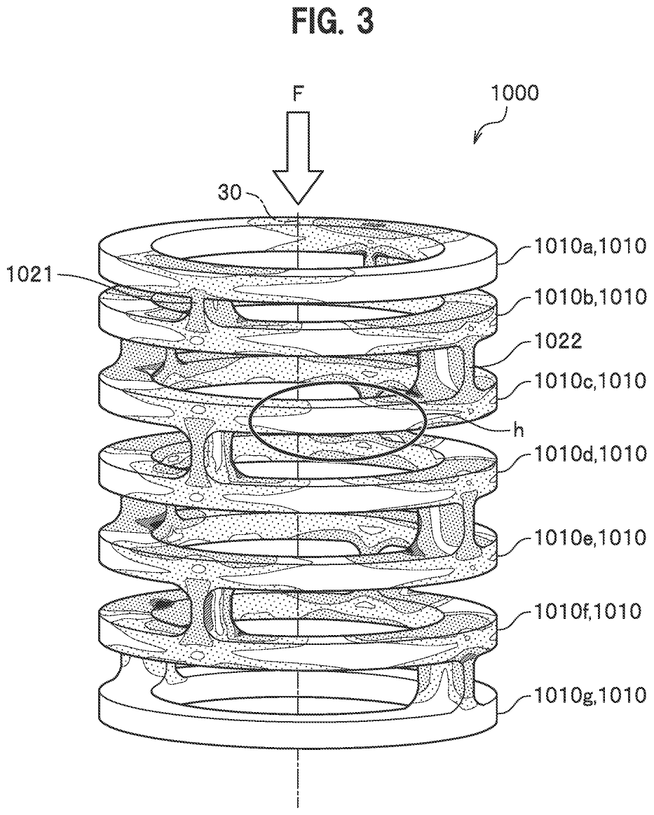

FIG. 3 is a diagram showing a distribution of stress exerted on the resinous spring 1000 of the comparative example shown in FIG. 2 when a load F is applied to the resinous spring 1000 from above. The contrasting density in FIG. 3 represents the unevenness of the stress distribution (the lighter the color, the greater the unevenness).

As indicated by the reference numeral h in FIG. 3, the resinous spring 1000 of the comparative example has locations with an uneven stress distribution when the ring-shaped members 1010a to 1010g are seen in the circumferential direction. For example, as indicated in the area surrounded by the oval line in FIG. 3, the stress distribution is uneven at portions of the ring-shaped members 1010a to 1010g between the first link members 1021 and the second link members 1022.

### (Principle Explained)

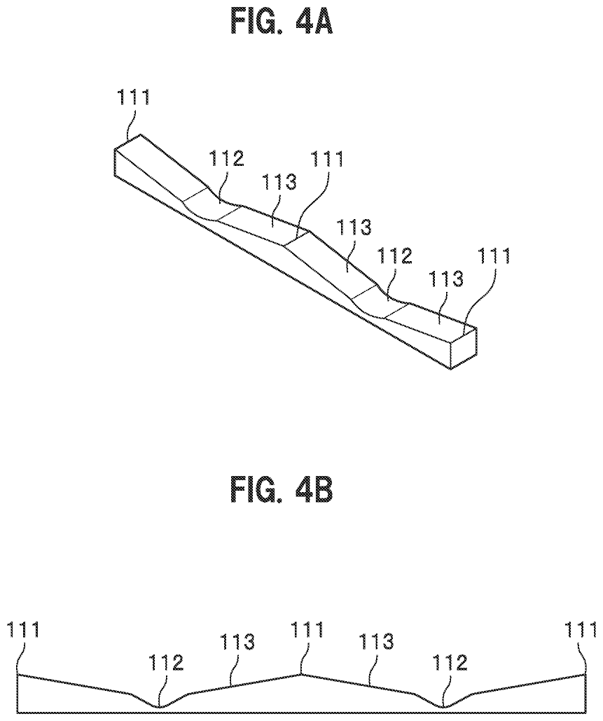

FIGS. 4A and 4B are diagrams illustrating the structure of a leaf spring constituting the ring-shaped member 10 of the resinous spring 1 according to the present embodiment, FIG. 4A being a perspective view of the leaf spring and FIG. 4B being a side view of the leaf spring. The same portions as those in FIG. 1 are denoted by the same reference numerals used in FIG. 1. For the convenience of illustration, FIGS. 4A and 4B each show a part (a circular arc) of the ring-shaped member 10 in the circumferential direction, extracted and straightened. Although FIG. 4A shows the leaf spring in a straight line, the leaf spring is actually circular-arc shaped.

Fixed End Beam Model FIGS. 4A and 4B show a half of the ring-shaped member 10b cut off at two vertex portions to which the second link members are connected, the half being straightened and used as a model for calculation of the relation between load and stress applied to the ring-shaped member 10b.

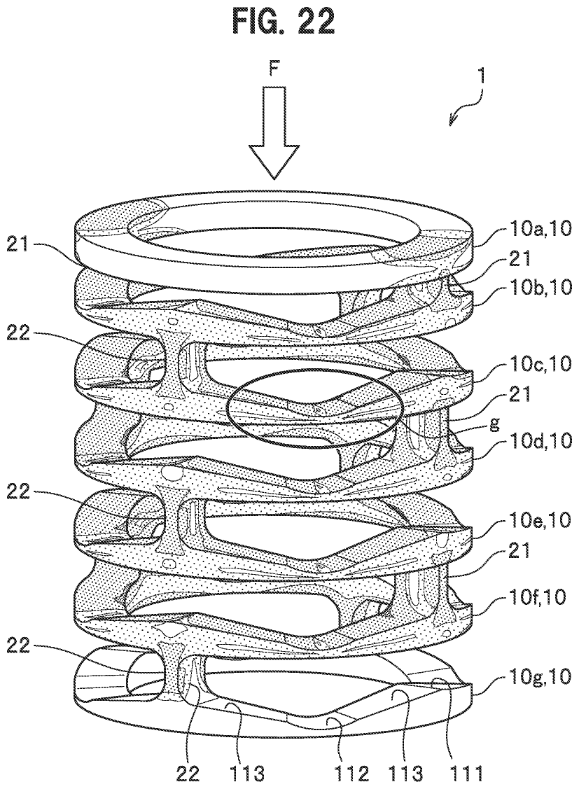

As shown in FIG. 22 (to be described later), when a load F is applied to the spring from above, the ring-shaped member 10b has the two vertex portions 111 supported by the second link members 22 from below and has another two vertex portions 111 receiving a load from above via the first link members 21.

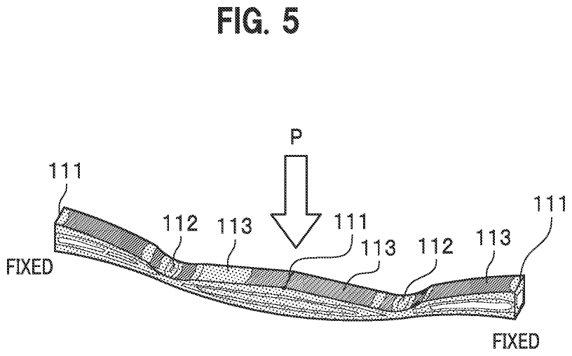

Referring back to FIGS. 4A and 4B, when the ring-shaped member 10b is cut in half at the two vertex portions 111 and straightened as described above, each of the halves of the ring-shaped member can be modeled as a fixed end beam in which the vertex portions 111 at both ends are fixed and the center vertex portion 111 receives the load F, as shown in FIG. 5 (to be described later). The same is true of the ring-shaped members 10c to 10d.

The vertex portions 111 are as high as the original thickness (i.e., the same as the comparative example) and are convex as compared to the thin portions 112 and the tapered portions 113. The vertex portions 111 at both ends are the end portions of the fixed end beam. The vertex portions 111 are connection portions to which the first link members 21 and the second link members 22 are connected.

FIG. 5 is a diagram showing a distribution of stress on the leaf spring in FIGS. 4A and 4B. The contrasting density in FIG. 5 represents the unevenness of the stress distribution (the lighter the color, the greater the unevenness).

In FIG. 5, the vertex portions 111 at both ends are fixed, forming a fixed end beam. When a force is applied from above as indicated by the reference numeral P in FIG. 5, no excessive stress is observed (as will be described later).

Fixed End Beam Calculation Formulae

A description is given of fixed end beam calculation formulae.

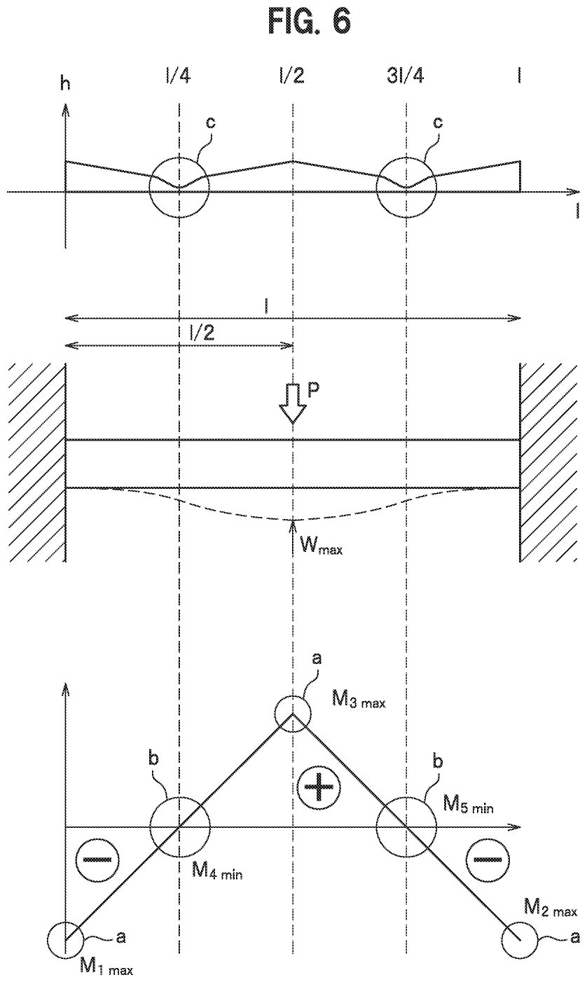

FIG. 6 is a diagram illustrating the calculation formulae for the fixed end beam in FIGS. 4A and 4B. The upper part of FIG. 6 is a side view of the fixed end beam in FIGS. 4A and 4B, the middle part of FIG. 6 is a diagram illustrating a stress on a typical fixed end beam, and the lower part of FIG. 6 is a diagram illustrating a bending moment diagram (BMD) corresponding to the middle part of FIG. 6.

As shown in the middle part of FIG. 6, the length (total length) of the fixed end beam is l, the length from each end to the center portion to which the force P is applied is l/2, and a half of that length is l/4, 3l/4.

In the fixed end beam shown in the middle part of FIG. 6, as indicated by the reference numeral a in the lower part of FIG. 6, the bending moments at the fixed ends are maximum M1max and M2max to the negative side, and the bending moment at the center portion to which the force P is applied is maximum M3max to the positive side.

As indicated by the reference numeral b in the lower part of FIG. 6, the bending moments M4 min and M5 min at the lengths l/4 and 3l/4 of the fixed end beam shown in the middle part of FIG. 6 have zero stress appearing. Since the portions at the l/4 and 3l/4 points have theoretically zero stress appearing, these portions can be reduced in thickness.

In the upper part of FIG. 6 where the horizontal axis represents the length l of the fixed end beam and the vertical axis represents the thickness (height) h of the fixed end beam, the portions of the fixed end beam at the l/4 and 3l/4 points can be reduced in thickness as indicated by the reference numeral c in the upper part of FIG. 6. The above-described relation between the bending moments of the fixed end beam and the stress distribution σ of the fixed end beam are expressed by Formulae (1) to (3).

$$\begin{matrix}[ Math . 1 ] & \\ {M}_{4} min , {M}_{5} min = 0 & ( 1 ) \\ {σ}_{max} = \frac{{M}_{1 , 2 , 3 max}}{Z} = \frac{3 P l}{4 b {h}^{2}} Z = \frac{1}{6} b {h}^{2} & ( 2 ) \\ {σ}_{4} , {σ}_{5} = \frac{{M}_{4} min , {M}_{5} min}{Z} = 0 & ( 3 )\end{matrix}$$

Thickness (Height) h of the Fixed End Beam

The thickness (height) h of the fixed end beam is now described.

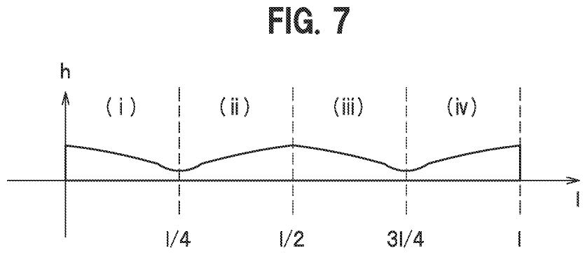

FIG. 7 is a diagram illustrating the design of the thickness (height) h of the fixed end beam. As shown in FIG. 7, the length of the fixed end beam is divided into a region (i) extending from one end portion to a l/4 point, a region (ii) extending from the l/4 point to a l/2 point, a region (iii) extending from the l/2 point to a 3l/4 point, and a region (iv) extending from the 3l/4 point to the other end portion 1.

The thickness (heights) h of the fixed end beam is found for each of the lengths of the fixed end beam by inserting the corresponding conditions based on Formula (2) given above. The thicknesses (heights) h of the respective regions in the fixed end beam are expressed by Formulae (4) to (7).

$$\begin{matrix}[ Math . 2 ] & \\ ( i ) 0 \leq x \leq \frac{l}{4} h = A \sqrt{l - 4 x} & ( 4 ) \\ ( ii ) \frac{l}{4} \leq x \leq \frac{l}{2} h = A \sqrt{4 x - l} & ( 5 ) \\ ( iii ) \frac{l}{2} \leq x \leq \frac{3 l}{4} h = A \sqrt{3 l - 4 x} & ( 6 ) \\ ( iv ) \frac{3 l}{4} \leq x \leq l h = A \sqrt{4 x - 3 l} & ( 7 )\end{matrix}$$

In the above formulae, l is the length of the fixed end beam model, and A is a constant.

Using the above Formulae (4) to (7), the thicknesses (heights) h of the fixed end beam are designed.

Structure of a Main Body Portion 110 of the Annular Member 10 (See FIG. 1) Based on the Thicknesses (Heights) h of the Fixed End Beam Thus Designed

To make the stress even, the height h of the parts indicated by the reference numeral c in the upper part of the FIG. 6 are theoretically zero. However, it then makes injection molding difficult. Thus, the above parts are actually given thickness by edge filleting. In the present embodiment, the height of each tapered portion 113 of the ring-shaped member 10 (see FIG. 1) is found using Formulae (4) to (7) given above. This allows the stress to be distributed over the entire area compared to a case where simple circular arcs are used, and thus enables the weight to be reduced effectively. [Simulation]

Shape of the Tapered Portions 113

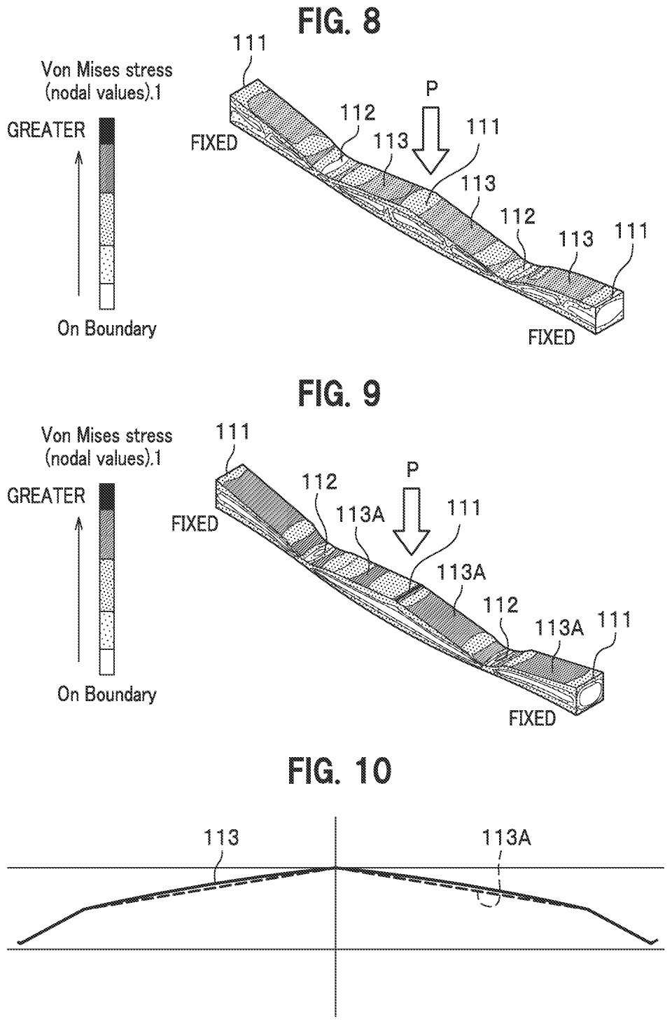

With reference to FIGS. 8 to 12, a description is given of the shape of the tapered portions 113.

FIG. 8 is a diagram showing a distribution of stress on a fixed end beam model constituting the ring-shaped member 10 of the present embodiment (see FIG. 1). Specifically, Formulae (4) to (7) are applied to the tapered portion 113 so that the tapered portion 113 forms a curved shape which is convex upward. In FIG. 8, the vertex portions 111 at both ends are fixed, forming a fixed end beam. As shown in FIG. 8, no excessive stress is observed when a force is applied to the fixed end beam from above.

FIG. 9 is a diagram showing a distribution of stress on a fixed end beam model of Comparative Example 2. In the fixed end beam model of Comparative Example 2, as demonstrated by FIG. 10 to be described later, a tapered portion 113A is straight, forming a flat surface. In the case of Comparative Example 2, an excessive stress is generated when a force is applied to the fixed end beam having the tapered portions 113A from above, as shown in FIG. 9.

FIG. 10 is a structure sectional diagram showing a comparison between the tapered portions of the fixed end beam model of the present embodiment shown in FIG. 8 and the tapered portions of the fixed end beam model of Comparative Example 2 shown in FIG. 9.

In the model of Comparative Example 2 where the tapered portions 113A are straight (see the broken lines in FIG. 10), the portions that need to be thick are thin, and thus, an excessive stress is generated. By contrast, in the fixed end beam model of the present embodiment having the tapered portions 113 (see the solid lines in FIG. 10), each tapered portion 113 is convex upward in thickness, and the stress is distributed at this portion, so that no excessive stress is observed.

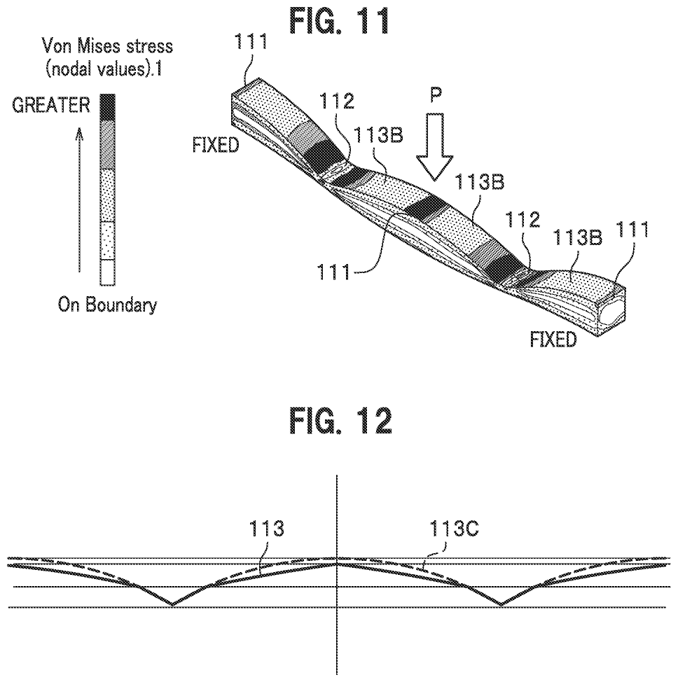

FIG. 11 is a diagram showing a distribution of stress on a fixed end beam model of Comparative Example 3. In the fixed end beam model of Comparative Example 3, as is apparent from FIG. 12 to be described later, tapered portions 113C are circular-arc shaped. As shown in FIG. 11, when a force is applied to the fixed end beam having the tapered portions 113C from above, an uneven stress is generated.

FIG. 12 is a structure sectional diagram showing a comparison between the tapered portions of the fixed end beam model of the present embodiment shown in FIG. 8 and the tapered portions of the fixed end beam model of Comparative Example 3 shown in FIG. 11.

The model of the comparative example where the tapered portions 113C are circular-arc shaped (see the broken lines in FIG. 12) has excessively thick portions, and therefore a stress generated therein is uneven. By contrast, in the fixed end beam model of the present embodiment having the tapered portions 113 (see the solid lines in FIG. 12), the tapered portions 113 are convex upward but with moderate thickness, and thus the stress generated therein is even in the longitudinal direction. Also, the fixed end beam model of the present embodiment is moderately thick and has been found to be approximately 20% more lightweight than the fixed end beam model of Comparative Example 3.

Comparison Between a Fixed End Beam Model Whose Upper Surface is Processed and a Fixed End Beam Model Whose Upper and Lower Surfaces are Processed (Both Surfaces are Processed)

A description is given of a comparison between a fixed end beam model whose upper surface is processed and a fixed end beam model whose upper and lower surfaces are processed (both surfaces are processed).

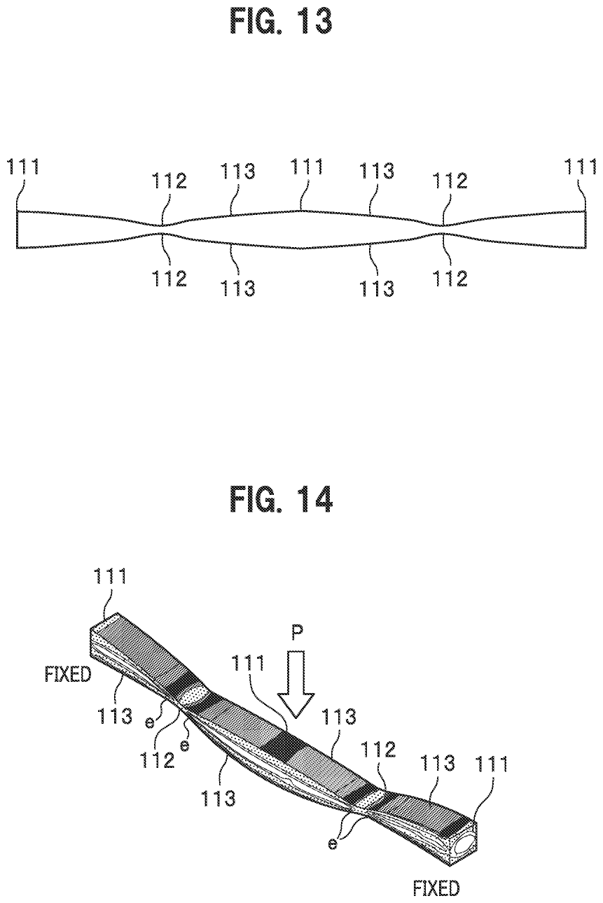

FIG. 13 is a side view of the fixed end beam model whose upper and lower surfaces are processed.

In the fixed end beam model shown in FIG. 13, the processing performed on the upper surface of the fixed end beam model in FIGS. 4A and 4B is similarly performed on the lower surface thereof as well. FIG. 14 is a diagram showing a distribution of stress on the fixed end beam model in FIG. 13.

The fixed end beam model in FIG. 13 whose upper and lower surfaces are processed is more lightweight than the fixed end beam model of the present embodiment. This is because the height (thickness) of the vertex portions 111 in FIG. 13 is the same as the height (position) of the vertex portions 111 shown in, e.g., FIG. 1. However, when a force is applied from above as indicated by the reference numeral e in FIG. 14, stress is concentrated at the thin portions 112. For this reason, the present embodiment employs the fixed end beam model whose upper surface is processed.

Comparison Between a Fixed End Beam Model Whose Upper Surface is Processed and a Fixed End Beam Model Whose Lower Surface is Processed

A description is given of a comparison between a fixed end beam model whose upper surface is processed and a fixed end beam model whose lower surface is processed.

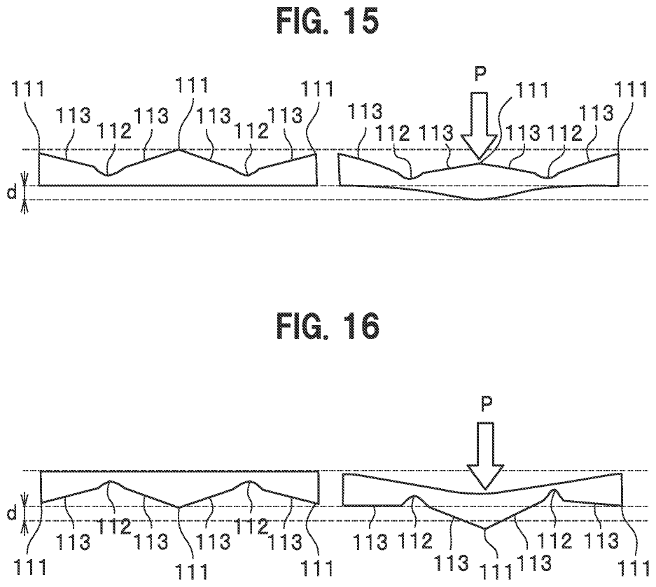

FIG. 15 is a side view of a fixed end beam model whose upper surface is processed, the right part of FIG. 15 showing an example state where no force is applied to the upper surface with both ends being fixed and the left part of FIG. 15 showing an example state where the fixed end beam is warped by application of a force to the upper surface with both ends being fixed. As shown in the right part of FIG. 15, the fixed end beam whose upper surface is processed warps by a small amount when a force is applied to the upper surface to warp the fixed end beam. Thus, the bottom surface portion of the beam is within the width d of warp deformation.

FIG. 16 is a side view of the fixed end beam model whose lower surface is processed, the right part of FIG. 16 showing an example state where no force is applied to the upper surface with both ends being fixed and the left part of FIG. 16 showing an example state where the fixed end beam is warped by application of a force to the upper surface with both ends being fixed. As shown in the right part of FIG. 16, the fixed end beam whose lower surface is processed warps by a large amount when a force is applied to the upper surface to warp the fixed end beam. Thus, the vertex portion 111 of the beam protrudes beyond the width d of warp deformation.

In this way, the fixed end beam constituting the ring-shaped member 10 of the present embodiment corresponds to the fixed end beam model shown in FIG. 15 whose upper surface is processed, or more specifically, the thin portions 112 are formed at the upper surface of the ring-shaped member 10, and the tapered portions 113 become thinner gradually toward the thin portions 112. Then, when a force is applied to the upper surface to warp the fixed end beam, the bottom surface portion of the main body portion 110 protrudes downward. This allows the fixed end beam constituting the ring-shaped member 10 of the present embodiment to have a low center of gravity. Also, compared to the fixed end beam model shown in FIG. 16 whose lower surface is processed, the fixed end beam model of the present embodiment warps by a small amount as shown in the right part of FIG. 15, which helps prevent bottoming out.

Arrangement of Plurality of Link Members 21, 22

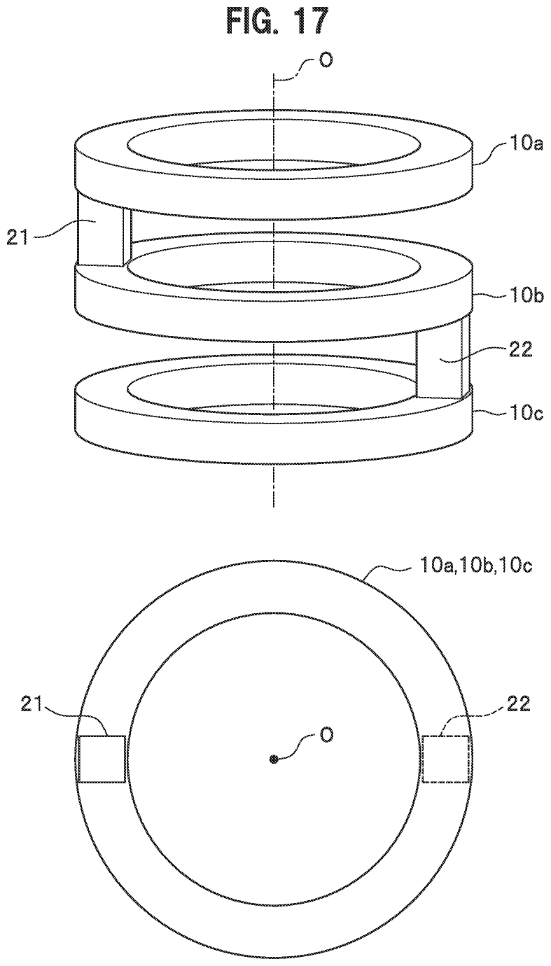

With reference to FIGS. 17 to 20, a description is given of the arrangement of the link members 21, 22. Note that for the purpose of illustrating the arrangement of the link members 21, 22, the shapes of the ring-shaped members 10 are simplified as ring-shaped shapes having an even thickness.

FIG. 17 is a schematic diagram illustrating the arrangement of the link members 21, 22 in a case with one link member 21 and one link member 22. The upper part of FIG. 17 is a perspective view, and the lower part of FIG. 17 is a plan view.

In the resinous spring shown in FIG. 17, upper and lower ring-shaped members are connected by a single link member at one location. Specifically, the ring-shaped member 10a and the ring-shaped member 10b are connected by the first link member 21, and the ring-shaped member 10b and the ring-shaped member 10c are connected by the second link member 22 disposed at a position which is offset from the above first link member 21 by one stage in the direction of the center axis O of the rings and which is opposite from the first link member 21 with the center axis O of the rings interposed therebetween.

In a plan view (seen in the direction of the center axis of the rings), the one first link member 21 and the one second link member 22 are disposed at two positions rotationally symmetric with respect to the center axis O of the rings (180°-angle positions with respect to the center axis O of the rings).

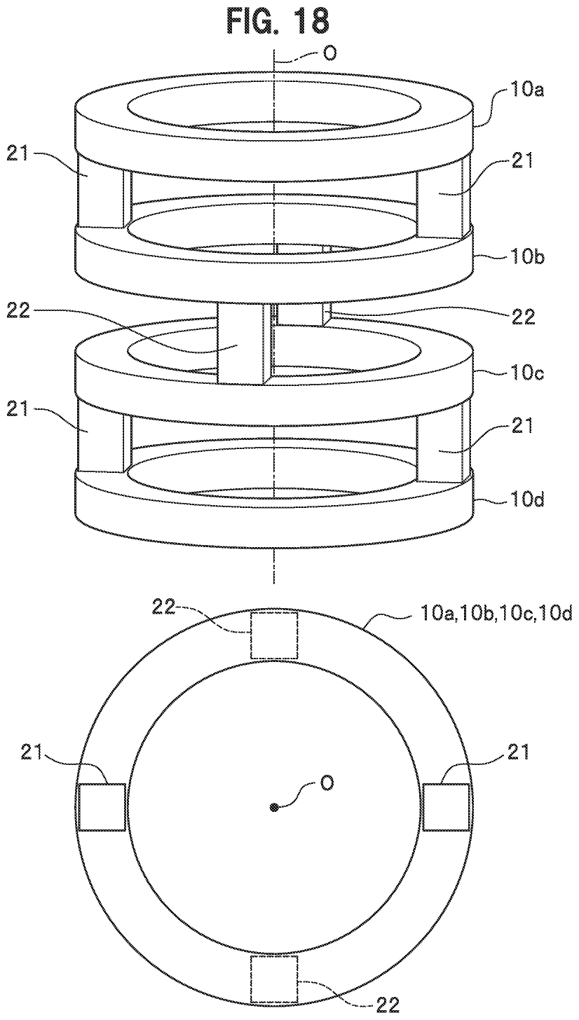

FIG. 18 is a schematic diagram illustrating the arrangement of the link members 21, 22 in a case with two link members 21 and two link members 22. The upper part of FIG. 18 is a perspective view, and the lower part of FIG. 18 is a plan view.

In the resinous spring shown in FIG. 18, upper and lower ring-shaped members are connected by two link members at two locations. In FIG. 18, the ring-shaped member 10a and the ring-shaped member 10b are connected by two first link members 21 at two locations, and the ring-shaped member 10b and the ring-shaped member 10c are connected by two second link members 22 at two locations.

The two first link members 21 are disposed at positions opposite from each other radially with the center axis O of the rings interposed therebetween. Similarly, the two second link members 22 are disposed at positions opposite from each other radially with the center axis O of the rings interposed therebetween.

The first link members 21 and the second link members 22 are disposed at positions not facing each other in the axial direction of the rings, and in this example, are disposed at positions such that a line connecting the first link members 21 facing each other in the radial direction of the rings is orthogonal to a line connecting the second link members 22 facing each other in the radial direction of the rings (at a 90° phase shift in the example in FIG. 18).

Specifically, the two first link members 21 are disposed at two positions rotationally symmetric with respect to the center axis O of the rings (and so are the two second link members 22). Since the first link members 21 and the second link members 22 are disposed at positions such that a line connecting the first link members 21 in the radial direction of the rings is orthogonal to a line connecting the second link members 22 in the radial direction of the rings, the two first link members 21 and the two second link members 22 are disposed at four positions rotationally symmetric with respect to the center axis O of the rings in a plan view (when seen in the direction of the center axis of the rings).

The angle by which the two link members 21 and the two link members 22 are offset from each other is determined as follows:

360°÷two locations÷2=90°

The arrangement of the link members 21, 22 shown in FIG. 18 corresponds to the arrangement of the first link members 21 and the second link members 22 of the resinous spring 1 in FIG. 1.

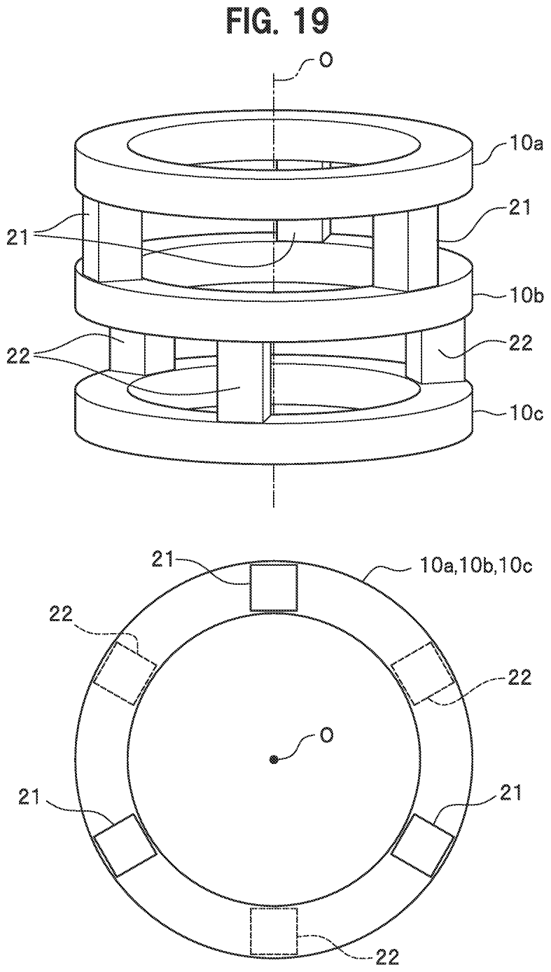

FIG. 19 is a schematic diagram illustrating the arrangement of the two kinds of link members 21, 22 in a case with three link members 21 and three link members 22. The upper part of FIG. 19 is a perspective view, and the lower part of FIG. 19 is a plan view.

In the resinous spring shown in FIG. 19, upper and lower ring-shaped members are connected at three locations using the two kinds of link members. In FIG. 19, the ring-shaped member 10a and the ring-shaped member 10b are connected by three first link members 21 at three locations, and the ring-shaped member 10b and the ring-shaped member 10c are connected by three second link members 22 at three locations.

The three link members 21 are disposed at positions offset from one another by 120° in the circumferential direction of the rings (and so are the three link members 22).

The first link members 21 and the second link members 22 are disposed at positions not facing each other in the axial direction of the rings, and in this example, are disposed to be offset from each other by 60° in the circumferential direction of the rings.

To be more specific, the three first link members 21 are disposed at three positions rotationally symmetric with respect to the center axis O of the rings (and so are the three second link members 22), and the first link members 21 and the second link members 22 are disposed to be offset from each other by 60° in the circumferential direction of the rings. Thus, the three first link members 21 and the three second link members 22 are disposed at six positions rotationally symmetric with respect to the center axis of the rings in a plan view (when seen in the direction of the center axis of the rings).

The angle by which the three link members 21 and the three link members 22 are offset from each other is determined as follows:

360°÷three locations÷2=60°

The resinous spring shown in FIG. 19 can be employed when the diameter of the ring-shaped members is to be increased or when the number of ring-shaped members is to be increased.

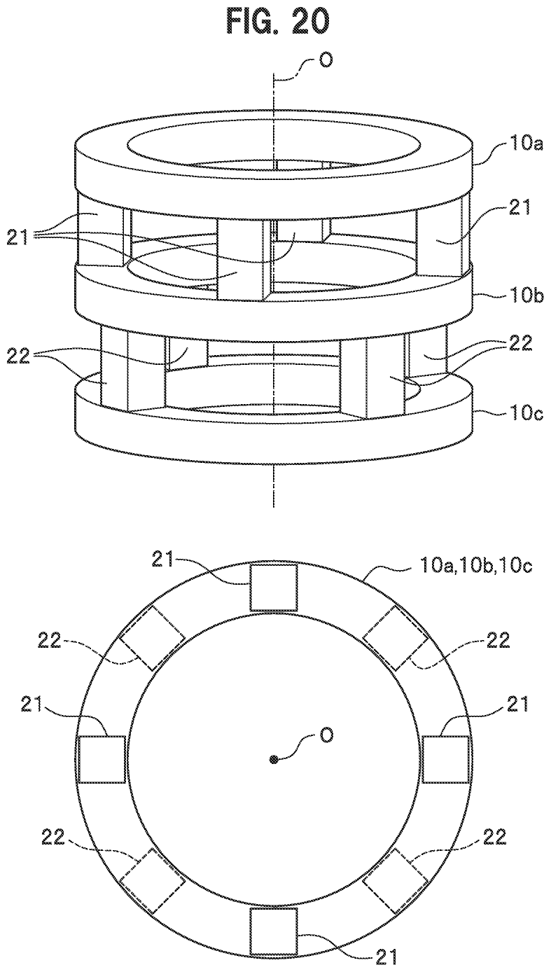

FIG. 20 is a schematic diagram illustrating the arrangement of the two kinds of link members 21, 22 in a case with four link members 21 and four link members 22. The upper part of FIG. 20 is a perspective view, and the lower part of FIG. 20 is a plan view.

In the resinous spring shown in FIG. 20, upper and lower ring-shaped members are connected at four locations using two kinds of link members. In FIG. 20, the ring-shaped member 10a and the ring-shaped member 10b are connected by four first link members 21 at four locations, and the ring-shaped member 10b and the ring-shaped member 10c are connected by four second link members 22 at four locations.

The four link members 21 are disposed at positions offset from one another by 90° in the circumferential direction of the rings (and so are the four link members 22).

The first link members 21 and the second link members 22 are disposed at positions not facing each other in the axial direction of the rings, and in this example, are disposed to be offset from each other by 45° in the circumferential direction of the rings.

The resinous spring shown in FIG. 20 can be employed when, as with the resinous spring shown in FIG. 19, the diameter of the ring-shaped members is to be increased or when the number of ring-shaped members is to be increased.

Vertical Gaps between Annular Members

A description is given of the vertical gaps between ring-shaped members.

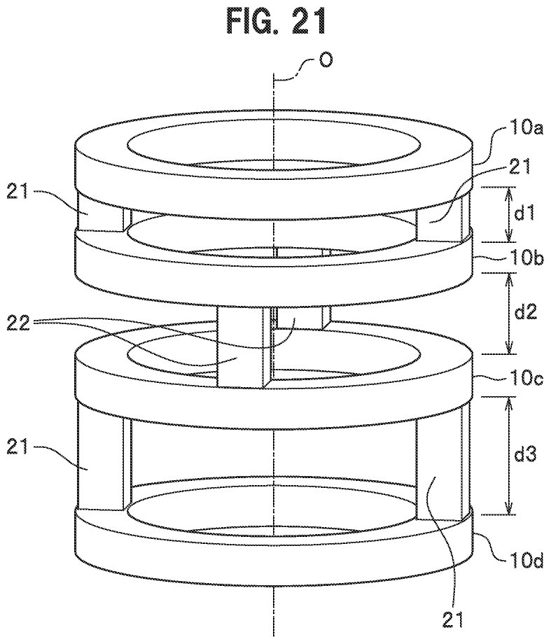

FIG. 21 is a perspective view schematically showing the vertical gaps between the ring-shaped members. For the purpose of illustrating the vertical gaps between the ring-shaped members, the shapes of the ring-shaped members 10 are simplified as ring-shaped shapes with an even thickness.

The resinous spring shown in FIG. 21 has different vertical gaps between the ring-shaped members. Specifically, the vertical gaps between the ring-shaped members 10a to 10d are different such that the gap between the ring-shaped member 10a and the ring-shaped member 10b is a distance d1, the gap between the ring-shaped member 10b and the ring-shaped member 10c is a distance d2, and the gap between the ring-shaped member 10c and the ring-shaped member 10d is a distance d3.

The vertical gaps of the ring-shaped members may be different from one another in any way. Not all the vertical gaps between the ring-shaped members need to be different, and some of the gaps may be the same.

### Advantageous Effects

As described thus far, the resinous spring 1 according to the present embodiment includes the plurality of ring-shaped members 10a to 10g disposed with gaps interposed therebetween in the direction of the spring axis 30 and the link members 21, 22 connecting adjacent ones of the ring-shaped members 10a to 10g. The link members include at least one first link member 21 and at least one second link member 22 for each of the ring-shaped members, the first link member 21 and the second link member 22 connecting the ring-shaped member to adjacent ones of ring-shaped members on one side and the other side of the ring-shaped member, respectively. The first link member 21 and the second link member 22 are disposed at positions not facing each other in the direction of the spring axis 30. The ring-shaped members 10a to 10g each include the vertex portions 111 to which the first link member 21 or the second link member 22 is connectable, the thin portions 112 where the ring-shaped member 10a to 10g is reduced in thickness in the direction of the spring axis 30, and the tapered portions 113 where the ring-shaped member 10a to 10g is reduced in thickness in the direction of the spring axis 30 gradually from the vertex portions 111 to the thin portions 112.

When the resinous spring 1 contracts, stress and strain are generated at the first link members 21 and the second link members 22 in the vertical direction and in their vicinity. In other words, stress and strain are unlikely to be generated at portions away from the first link members 21 and the second link members 22. As described in the Principle Explained section, in the resinous spring 1 according to the present embodiment, the thin portions 112 are disposed at positions where the stress and strain are unlikely to be generated, which makes it possible to make the spring lightweight without compromising the rigidity of the spring.

FIG. 22 is a diagram showing a distribution of stress exerted on the resinous spring 1 when a load F is applied thereto from above. The same constituents as those in FIG. 1 are denoted by the same reference numerals used in FIG. 1.

As indicated by the reference numeral g in FIG. 22, the resinous spring 1 has an even distribution of stress. Since the load applied to the resinous spring 1 is thus distributed, the resinous spring 1 is less likely to break by application of pressure. This point is more apparent from a comparison with the comparative example in FIG. 3 employing the same conditions.

Since the resources over which the applied load is distributed are thus reduced in thickness by the provision of the thin portions 112 to the ring-shaped members 10, the spring can be reduced in weight without the rigidity thereof being compromised.

In the present embodiment, the thin portions 112 are each disposed at a halfway point between two vertex portions adjacent in the circumferential direction of the ring-shaped member 10a to 10g. As described in the Principle Explained section, almost no stress is exerted on this halfway portion when a load is applied, and therefore, even if the main body portion 110 is reduced in thickness at those portions, the resinous spring 1 does not break upon receipt of pressure and can be reduced in weight optimally.

In the present embodiment, the link members 21, 22 linked to each ring-shaped member are disposed as follows. A number n of the first link members 21 are disposed at n positions rotationally symmetric with respect to the center axis of the rings, and the same number n of second link members 22 as the number of the first link members 21 are disposed such that the first link members 21 and the second link members 22 are disposed at 2n positions rotationally symmetric with respect to the center axis of the rings. When the link members are disposed at n positions rotationally symmetric with respect to the center axis of the rings, a force applied to the spring is distributed evenly in the radial direction with respect to the spring axis 30, which enables evening out of the stress generated.

In the present embodiment, in a case where two first link members 21 and two second link members 22 are disposed for each ring-shaped member, the theoretical value of the thickness h of the ring-shaped member in the axial direction of the spring is expressed by Formulae (4) to (7) given above, and with respect to the theoretical value of the thickness h, each thin portion 112 connects the tapered portions located on both sides of the thin portion in the circumferential direction to each other, forming a circular-arc shape. This enables designing of the thickness of the thin portions 112 where there is no concentration of stress. This enables evening out of stress generated and achieves reduction in weight by approximately 20% compared to the configuration with simple circular arcs.

In the present embodiment, by the thin portions 112, the ring-shaped member is reduced in thickness in the axial direction only on one side thereof. This helps prevent the ring-shaped member from warping too much. Also, reducing the thickness of the main part at the thin portions 112 at the upper surface enables the center of gravity to be low, which allows the ring-shaped member to warp less than a ring-shaped member that is reduced in thickness gradually at the lower surface and therefore helps prevent bottoming out.

In the present embodiment, each tapered portion 113 has a curved surface which is convex in the axial direction of the spring. When the tapered portion 113 were formed in a simple circular-arc shape, not only the thickness would increase, but also the stress generated would be uneven. When the tapered portion 113 has a curved surface which is convex upward, the weight can be reduced more than the structure with simple circular arcs, without making the stress generated uneven.

The plurality of embodiments described above are examples of how the present embodiment may be embodied. Thus, the technical scope of the present invention is not to be interpreted as being limited to those embodiments because the present invention can be implemented in various modes without departing from the gist and main features thereof.

For example, although the resinous spring described above has ring-shaped members with the same diameter, the spring may have a barrel shape having a larger diameter at the center area in the axial direction or, conversely, a tsuzumi (Japanese hand drum) shape having a smaller diameter at the center area. The ring-shaped members constituting the spring may have different thicknesses vertically and/or radially. Instead of having a circular shape, each ring-shaped member may have a regular polygonal shape. In that case, with respect to the number n of the first and second link members connecting each ring-shaped member (four in FIG. 18), the shape of the ring-shaped member is desirably a regular n-gon or a regular polygon with an integer multiple of n (a regular 2n-gon, a regular 3n-gon, and so on).

What is claimed is:

1. A resinous spring comprising:
a plurality of ring-shaped members disposed with gaps interposed therebetween in an axial direction of the spring; and
link members each connecting adjacent ones of the ring-shaped members, wherein
the link members include at least one first link member and at least one second link member for each of the ring-shaped members, the first link member and the second link member connecting the ring-shaped member to adjacent ones of the ring-shaped members on one side and the other side of the ring-shaped member, respectively,
the first link member and the second link member are disposed at positions not facing each other in the axial direction of the spring, and
each of the ring-shaped members includes
vertex portions to each of which the first link member or the second link member is connectable,
thin portions where the ring-shaped member is reduced in thickness in the axial direction of the spring, and
tapered portions where the ring-shaped member is reduced in thickness in the axial direction of the spring gradually from the vertex portions to the thin portions.

2. The resinous spring according to claim 1, wherein
each of the thin portions is disposed at a halfway point between two of the vertex portions adjacent in a circumferential direction of the ring-shaped member.

3. The resinous spring according to claim 1, wherein
of the link members linked to each of the ring-shaped members,
a given natural number n of the first link members are disposed at n positions rotationally symmetric with respect to a center axis of the ring-shaped members, and
the same number of the second link members as the number of the first link members are disposed such that the first link members and the second link members are disposed at 2n positions rotationally symmetric with respect to the center axis of the ring-shaped members.

4. The resinous spring according to claim 1, wherein
in each of the ring-shaped members in a case where the first link members are disposed at two locations and the second link members are disposed at two locations,
a theoretical value of a thickness h of the ring-shaped member in the axial direction of the spring is expressed by formulae given below, and
with respect to the theoretical value of the thickness h, each of the thin portions connects the tapered portions on both sides of the thin portion in the circumferential direction to each other in a circular-arc shape:
$$\begin{matrix}[ Math . 2 ] & \\ ( i ) 0 \leq x \leq \frac{l}{4} h = A \sqrt{l - 4 x} & ( 4 ) \\ ( ii ) \frac{l}{4} \leq x \leq \frac{l}{2} h = A \sqrt{4 x - l} & ( 5 ) \\ ( iii ) \frac{l}{2} \leq x \leq \frac{3 l}{4} h = A \sqrt{3 l - 4 x} & ( 6 ) \\ ( iv ) \frac{3 l}{4} \leq x \leq l h = A \sqrt{4 x - 3 l} & ( 7 )\end{matrix}$$
where l is half an outer circumferential length of the ring-shaped member seen in a direction of the axial direction of the spring, and A is a constant.

5. The resinous spring according to claim 1, wherein
at the thin portions, the ring-shaped members are each reduced in thickness in the axial direction thereof at only one side of the ring-shaped member.

6. The resinous spring according to claim 1, wherein
the tapered portions each have a curved surface which is convex in the axial direction of the spring.
